(19) United States
(12) Patent Application Publication
(10) Pub. No.: US 2016/0263741 A1
(43) Pub. Date: Sep. 15, 2016

(54) Free Arm Worker Support

(71) Applicant: Harvey Dale Shaner, Belleview, FL (US)

(72) Inventor: Harvey Dale Shaner, Belleview, FL (US)

(21) Appl. No.: 14/988,492

(22) Filed: Jan. 5, 2016

Related U.S. Application Data
(60) Provisional application No. 62/124,792, filed on Jan. 5, 2015.

(51) Int. Cl. B25H 5/00

(52) U.S. Cl. CPC B25H 5/00

(57) ABSTRACT

The design has a top section using a pillow type head rest and a specially designed body support deck.

This is supported by a body support beam attached to a pivot pin on the base section. The adjustable strut is attached to the base using two telescoping tubes with a lock pin locater. (the seat with attachments uses the same general design)

The base uses four castors with a connecting support beam.

The “F.AW.S.” has a top section where a worker lies on either his left or right side to work on floors, low wall construction, or for repairs.

The head and body support deck having openings on each side for a worker to extend his arm and shoulder below the body support deck as he lies on his side for free arm movement work. The body support deck has fasteners to hold it in the workers most advantageous position to the body support beam.

The body support beam is attached to a pivot pin at one end on the base section having slots for adjustment of the body support deck to allow for different workers height. Also having fasteners to attach to the adjustable devise below.

A worker may change levels of the body support deck by an adjustable strut as shown on the drawing sheet. The adjustable strut is a two tube telescoping action devise with a hand placed lock pin all supported by the base section, to support the pivoted body support beam and the pivoted seat support beam.

The riser blocks are used to elevate the support beam, one at each end and one in the middle to allow a minimum free space for the worker's arm and shoulder.

The seat and support beam is a unit, using the same general design and working as the body support deck.

### Operating the “Free Arm Worker Support”:

The worker, lying on his side, rolls the “F.A.W.S.” on four easy rolling casters into a working position. After locking two casters, with tools in hand, does work with arms and hands free, to do his assigned work.

### SPECIFICATION DESCRIPTION OF DRAWING VIEWS

FIG. 1. Is a front elevation View of the “FREE ARM WORKER SUPPORT”.

FIG. 2. Is a front elevation view showing adjustable features also showing the structure and casters there of.

FIG. 3. Is a top plan view showing location of 2 casters with 2 hiden casters at the opposite corners (4casters) and showing the location of 2 adjustable struts in line one for the body support and one hidden for the seat support.

FIG. 4. Is a section view 4-4 showing, a clear space on left and right side, under the body support deck plate, where the worker's lower arm and shoulder are free to work, as the deck plate supports his body above. (while the worker lies on his side)

FIG. 5. Is a partial detail of the adjustable strut (shown for clarity of understanding only) used for the body support and the seat support.

FIG. 6. Is a partial detail of the lock pin (shown for clarity of understanding only) used with adjustable strut.

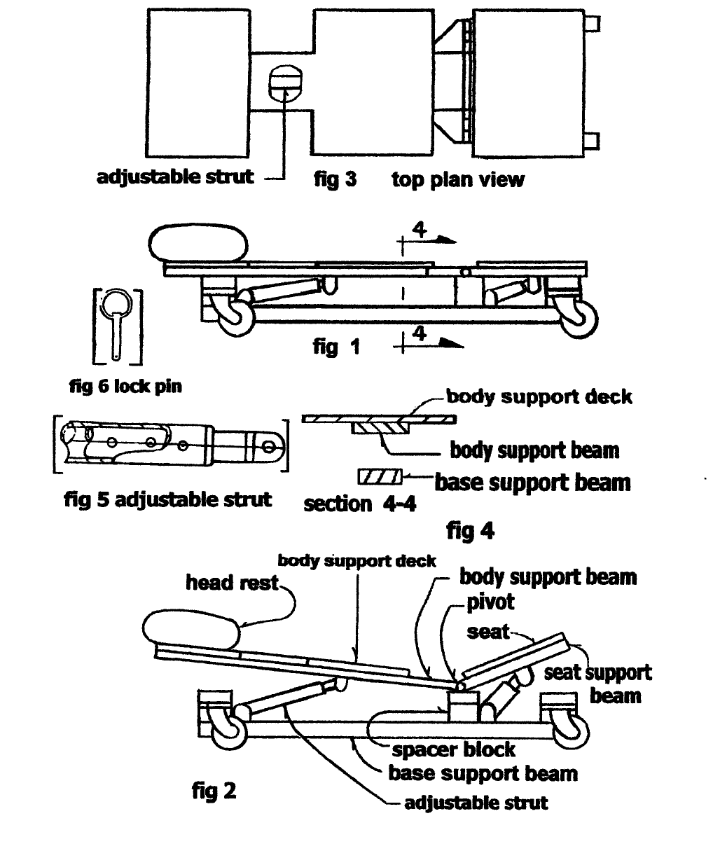

1. is a special designed head and body support deck having openings on each side for a worker to extend his arm and shoulder below the deck as he lies on his side for free arm movement work. The plate has fasteners to hold it in the workers most advantageous position on the body support beam. cl 2

2. is a body support beam attached to a pivot pin at one end on the base section having slots to accommodate fasteners on the body support deck cl 1 to allow for different peoples height also complete with fasteners to attach to the adjustable strut.

3. is a seat support beam with seat attached and a pivot at one end, attached to the base section also attached to an adjustable strut allowing selection of different working positions
